(19) United States
(12) Patent Application Publication
(10) Pub. No.: US 2026/0349645 A1
(43) Pub. Date: Nov. 5, 2026

(54) VISUAL CONTENT OUTPUT MANAGEMENT USING SENSOR DATA

(71) Applicant: Lenovo (Beijing) Limited, Beijing (CN)

(72) Inventors: Qing-Shuai Zhu, Naperville, IL (US); Xiaofeng Zhu, Nanjing (CN); Sanjay Dhar, Algonquin, IL (US)

(73) Assignee: Lenovo (Beijing) Limited, Beijing (CN)

(21) Appl. No.: 19/374,722

(22) Filed: Oct. 30, 2025

Related U.S. Application Data
(63) Continuation of application No. PCT/CN2025/092740, filed on May 1, 2025.

(51) Int. Cl. G06F 3/14; G06F 1/16; G09G 3/34

(52) U.S. Cl. CPC G06F 3/1454; G06F 1/1641; G06F 1/1647; G06F 1/1677; G06F 3/1431; G09G 3/3406; G09G 2320/0626

(57) ABSTRACT

In aspects of visual content output management using sensor data, a device including a first housing and a second housing foldably coupled with the first housing detects a user is within a threshold proximity to at least one of the first housing or the second housing and an ambient light of an environment of the device satisfies a threshold value. An angle of the first housing relative to the second housing satisfies a threshold value. The device refrains from outputting visual content at a display of the first housing and outputs a mirrored version of the visual content at a display of the second housing. The device receives input at the display of the first housing that causes the device to update the mirrored version of the visual content. The device outputs the update to the mirrored version of the visual content at the display of the second housing.

### RELATED APPLICATION

This application claims priority benefit of Application Number PCT/CN2025/092740 filed 1 May 2025 entitled “Visual Content Output Management using Sensor Data,” the disclosure of which is incorporated by reference herein in its entirety.

### BACKGROUND

Devices, such as smart devices, mobile devices (e.g., cellular phones, tablet devices, smartphones), consumer electronics, and the like, can be implemented for use in a wide range of environments and for a variety of different applications. The devices can include and/or can implement one or more sensors to detect environmental conditions and user interactions with the devices. In some examples, the devices can include multiple housings (e.g., different sections of the devices) that can be folded, where a device with the multiple housings can be referred to as a foldable device.

### BRIEF DESCRIPTION OF THE DRAWINGS

Implementations of the techniques for visual content output management using sensor data are described with reference to the following Figures. The same numbers may be used throughout to reference like features and components shown in the Figures:

FIG. 1 illustrates an example system for visual content output management using sensor data in accordance with one or more implementations as described herein.

FIG. 2 illustrates an example of a foldable mobile device for visual content output management using sensor data in accordance with one or more implementations as described herein.

FIG. 3 illustrates an example environment for visual content output management using sensor data in accordance with one or more implementations as described herein.

FIG. 4 illustrates an example display diagram for visual content output management using sensor data in accordance with one or more implementations as described herein.

FIG. 5 illustrates an example flowchart for visual content output management using sensor data in accordance with one or more implementations as described herein.

FIGS. 6 and 7 illustrate examples of methods for visual content output management using sensor data in accordance with one or more implementations of the techniques described herein.

FIG. 8 illustrates various components of an example device that can be used to implement the techniques for visual content output management using sensor data as described herein.

### DETAILED DESCRIPTION

Implementations of techniques for outputting visual content based on sensor data are described herein. In some examples, a device (e.g., a mobile device, a foldable device, or any other device) can implement one or more applications or services that manage visual content output across multiple displays. For example, the device implements one or more applications or services that detect environmental conditions and user proximity to determine which of the multiple displays output the visual content. In some cases, the device receives sensor data from multiple sensors to trigger or adjust (e.g., update) the output of the visual content across the displays.

Conventional techniques for managing display of visual content across multiple displays, such as at least an upper display and a lower display of a foldable device, may not account for environmental factors and user behavior when determining how to display content. For example, conventional techniques may not use ambient light levels or user proximity when determining whether to display content at an upper display and/or at a lower display of the device. Additionally, or alternatively, conventional foldable devices may be unable to mirror or reflect content between an upper display and a lower display based on device orientation and environmental conditions. The foldable device failing to use ambient light levels and user proximity and/or failing to mirror or reflect content can lead to excessive brightness of the display in relatively low ambient light levels (e.g., ambient light below a threshold value). The excessive brightness may also disturb other individuals within a threshold distance from the device. Further, a user may be unable to view the visual content at one or more displays of the foldable device due to glare or unintended reflection from the lower display to the upper display or light disruption from the upper display to the lower display.

As described herein, to reduce or eliminate excessive brightness at a foldable device and to reduce glare or unintended reflection between displays of the foldable device, a device with multiple foldable displays can perform dynamic visual content output using sensor data. In some examples, the device can implement one or more sensors to detect that the device is at least partially folded. The device can implement one or more additional sensors to detect that a user is within a threshold proximity (e.g., distance) to the device and that an ambient light of an environment of the device is less than a threshold value. The device can refrain from outputting visual content at a lower display of the device and can output a mirrored version of the visual content at an upper display of the device, such that the device reflects the visual content of off the lower display of the device. The device can receive input at the lower display and can correlate the input to the upper display to update the mirrored version of the visual content accordingly. Additionally, or alternatively, if the user is outside of the threshold proximity and/or of the ambient light is greater than the threshold value, then the device outputs the visual content at the lower display and refrains from outputting the visual content at the upper display. The device can receive input at the lower display and can update the visual content at the lower display accordingly.

By leveraging sensor data to dynamically manage (e.g., control, perform) display of visual content at different displays of a foldable device, the foldable device can reduce or eliminate excessive brightness and glare, while improving viewing experience for a user of the foldable device. In some cases, in conditions with relatively low ambient light (e.g., less than a threshold value) and when the user is within a threshold proximity from the device, the device may output a mirrored version of the visual content on the upper display, providing for the user to view the reflected content on the lower display without direct light emission. Outputting the mirrored version of the visual content on the upper display may reduce eye strain and reduce or minimize disturbance to others nearby. In some other cases, in conditions with relatively high ambient light (e.g., greater than the threshold value) or when the user is outside of the threshold proximity from the device, the device may output content directly on the lower display for improved visibility. By dynamically adjusting the content output based on environmental factors (e.g., ambient light) and user proximity, the device may improve power consumption by reducing excessive brightness and improve usability in various scenarios. For example, the device may reduce unintended reflections between displays of the device by selectively activating one display at a time to reduce glare and to improve clarity of the visual content.

While features and concepts of the described techniques for visual content output management using sensor data can be implemented in any number of different devices, systems, environments, and/or configurations, implementations of the techniques for visual content output management using sensor data are described in the context of the following example devices, environments, sensor diagrams, systems, flowcharts, and methods.

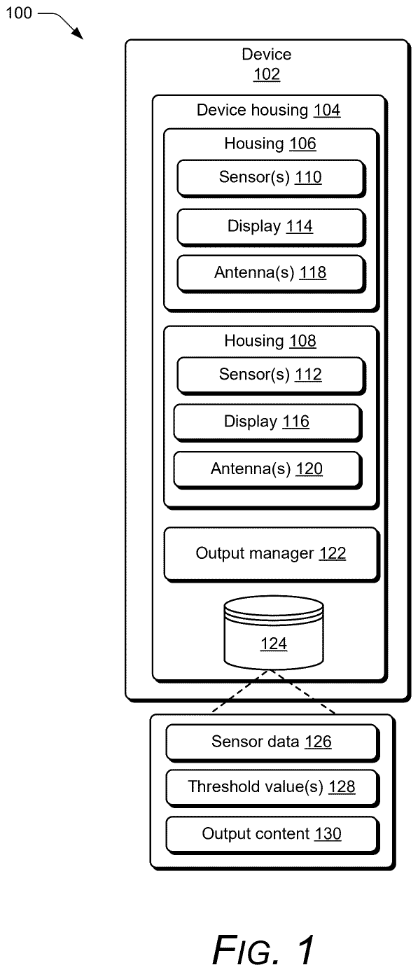

FIG. 1 illustrates an example system 100 for visual content output management using sensor data, as described herein. The example system 100 includes a device 102, which may be communicatively coupled with one or more other devices (e.g., via a network). The device 102 may exchange signaling, including control signaling and/or data, with one or more other devices via a wireless communications link in the network (e.g., a cellular network, a Wi-Fi network, or another wireless network). The device 102 may range from a full resource device or system with substantial memory and processor resources to a low-resource device or system with reduced memory and processing resources. Although in instances in the following discussion reference is made to a device 102 in the singular, the device 102 may be representative of multiple different devices or systems. The device 102 may include one or more features in addition to, or as an alternative to, the features in the system 100.

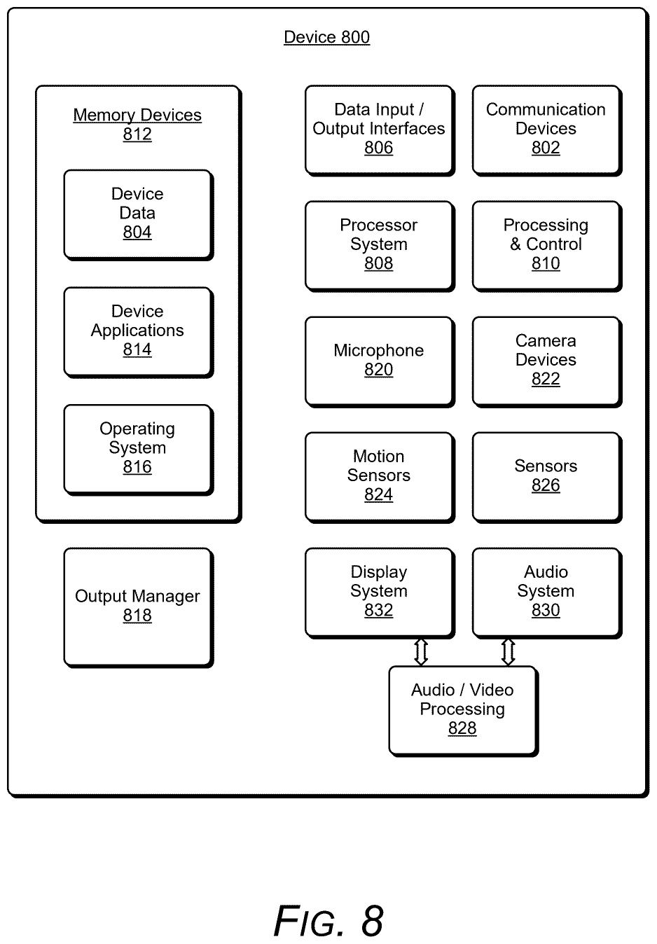

In some examples, the device 102 is an example of a user equipment (UE), a smartphone, a mobile phone, a wearable device, and/or any other type of wireless device or mobile device. The device 102 can be implemented with various components, such as a processor system and memory, as well as any number and combination of different components as further described with reference to the example device shown in FIG. 8. The device 102 may be a foldable device, which refers to a device with multiple housings that can be folded relative to one another. Example foldable devices include, but are not limited to, smartphones with foldable displays (e.g., displays that rotate or hinge relative to one another), laptops with hinges that provide for rotation of the display and/or the keyboard, tablets with detachable keyboards, or multi-fold devices with two or more housings.

The device 102 can include a device housing 104, which may be divided into multiple portions or housings. For example, the device housing 104 may include, but is not limited to, a housing 106 and a housing 108. The housing 106 may be foldably coupled with the housing 108, in that the housing 106 and the housing 108 are connected by a hinge or flexible joint that provides for the housing 106 and the housing 108 to fold together (e.g., such that one or more edges or surfaces of the housings are touching) or apart (e.g., such that a single edge or fewer of the housings is touching). The device 102 can include any number of housings and foldable configurations, such as dual-screen devices, flip phones, or multi-fold designs that fold more than once.

The housing 106 can include one or more sensors 110, and the housing 108 can include one or more sensors 112. The sensors 110 and the sensors 112 may include, but are not limited to, capacitor sensors, proximity sensors, accelerometers, gyroscopes, or other types of sensors capable of detecting an orientation of the device 102, movement of the device 102, or proximity of the device 102 (e.g., the housing 106 and/or the housing 108) to a user. For example, capacitor sensors in the housing 106 and in the housing 108 can detect changes in capacitance when near (e.g., within a threshold distance from or proximity to) a user. The capacitor sensors measure capacitance values that change when human tissue or other surfaces come within a detection distance (e.g., within 5 millimeters or another predetermined or defined distance threshold). In some cases, the device 102 may use the data collected by the sensors 110 and/or the sensors 112 to dynamically adjust output at different displays of the device 102 (e.g., a display 114 at the housing 106 and a display 116 at the housing 108). For example, if the data indicates that the user is within a threshold proximity from the housing 106 and/or the housing 108 of the device 102, then the device 102 may not output visual content at a lower display (e.g., a display 116) and may output a mirrored version of visual content at an upper display (e.g., a display 114), which is reflected off of the lower display. In some other examples, if the data indicates that the user is outside of the threshold proximity from the housing 106 and/or the housing 108 of the device 102, then the device 102 may output the visual content at a lower display (e.g., the display 116) and may not output the visual content at an upper display (e.g., the display 114).

The device 102 not outputting the visual content at a display (e.g., the display 114 and/or the display 116) may also be referred to the device 102 turning off the display, refraining from outputting at the display, or canceling output of visual content at the display, among other examples. Although the device 102 does not output visual content at the display, the display may still be activated for receiving input at the display (e.g., user input). If the device 102 is not outputting the visual content at a display, then the display may appear dark.

Additionally, or alternatively, the sensors 110 and the sensors 112 may include, but are not limited to, photodiodes, light-dependent resistors (LDRs), or other sensors that can detect and measure the intensity or level of ambient light in the environment surrounding the device 102. The sensors 110 and the sensors 112 for detecting ambient light may be positioned at various locations at the housing 106 and/or the housing 108 to capture ambient light data from different angles and orientations of the device 102. The device 102 can use the data collected by the ambient light sensors to determine when to output visual content at different displays of the device 102, including the display 114 and the display 116. If the user is within a threshold proximity and the ambient light sensors detect low light conditions (e.g., below a defined threshold value), then the device 102 may may not output visual content at a lower display (e.g., a display 116) and may output a mirrored version of visual content at an upper display (e.g., a display 114), which is reflected off of the lower display. In some other examples, if the user is outside of the threshold proximity or the ambient light sensors detect light conditions above the defined threshold value, then the device 102 may output the visual content at a lower display (e.g., the display 116) and may not output the visual content at an upper display (e.g., the display 114).

Additionally, or alternatively, the sensors 110 and the sensors 112 may include, but are not limited to, hall effect sensors, magnetometers, or other sensors that can detect the relative orientation or angle between the housing 106 and housing 108. For example, a hall effect sensor in one housing may detect the magnetic field of a magnet in the other housing, with the strength of the detected field indicating the angle between the housings. Additionally, or alternatively, an angle sensor such as a potentiometer or rotary encoder may be integrated into the hinge mechanism connecting the housing 106 and the housing 108 to directly measure a fold angle of the device 102 (e.g., an angle between the housing 106 and the housing 108). The device 102 can use the fold angle data to determine when to output visual content at different displays of the device 102, including the display 114 and the display 116. If the fold angle is within a threshold range (e.g., greater than a first threshold value and less than a second threshold value), then the device 102 may may not output visual content at a lower display (e.g., a display 116) and may output a mirrored version of visual content at an upper display (e.g., a display 114), which is reflected off of the lower display. In some other examples, if the fold angle is outside of the threshold range, then the device 102 may output the visual content at a lower display (e.g., the display 116) and may not output the visual content at an upper display (e.g., the display 114).

The display 114 can be an example of a user interface integrated at a housing 106 that is an upper housing of the device 102 (e.g., above the housing 108). The display 116 can be an example of a user interface integrated at a housing 108 that is a lower housing of the device 102 (e.g., below the housing 106). The user interfaces at the display 114 and the display 116 provide for user interaction with the device 102. For example, the user interfaces may include graphical user interfaces (GUIs) for displaying visual content, touchscreens, physical buttons, voice recognition systems, or gesture controls, among other examples. For a foldable device, different user interfaces may be active depending on a folded state of the foldable device. For example, when fully folded, a smaller external display may be active, while unfolding the device might activate a larger internal display spanning multiple housings.

The housing 106 can include one or more antennas 118, and the housing 108 can include one or more antennas 120. The antennas 118 and the antennas 120 are components for wireless communication, which may include cellular antennas, Wi-Fi antennas, Bluetooth antennas, or near-field communication antennas, among other examples. The antennas 118 and the antennas 120 enable the device 102 to transmit and receive wireless signals (e.g., signaling, messages). In a foldable device, antennas may be distributed across different housings, including the housing 106 and the housing 108 at the device 102, to provide for connectivity regardless of a folded state of the device 102. The device 102 may implement the antennas 118 and the antennas 120 to exchange (e.g., transmit, receive) signaling. The device 102 can output the signaling for display at the display 114 and/or at the display 116. The signaling may include, but is not limited to, messages (e.g., messages including text and/or audio) received from other mobile devices or messaging platforms and application updates, such as news alerts, system updates, weather updates, or reminders, among other examples. In some cases, the device 102 may process the signaling and determine which display (e.g., the display 114 and/or the display 116) to use for outputting corresponding visual content based on a fold angle of the housing 106 and the housing 108, ambient light conditions, and user proximity.

The output manager 122 at the device 102 controls the display of visual content and audio content based on sensor data from the sensors 110 and the sensors 112. In some cases, the output manager 122 may be implemented as a combination of hardware and software, such as a dedicated microcontroller with firmware specifically designed to manage display output based on sensor inputs. The output manager 122 may interface with other components of the device 102, such as the sensors 110, the sensors 112, the display 114, the display 116, the antennas 118, and the antennas 120, to gather data and control output in real-time. As used herein, real-time may refer to the processing and response to input data or events as they occur with less than a threshold delay between the input and the corresponding output or action (e.g., within milliseconds or microseconds depending on the application and system capabilities of the device 102). The output manager 122 accesses data storage 124 to obtain sensor data 126, one or more threshold values 128, and output content 130. The device can collect the sensor data 126 (e.g., a fold angle between the housing 106 and the housing 108, ambient light levels, and user proximity) using the sensors 110 and the sensors 112 and can store the sensor data 126 at the data storage 124.

The data storage 124 may include local storage components integrated within the device 102, such as solid-state drives, flash memory, or random-access memory (RAM). In some cases, the data storage 124 may include volatile memory for temporary data storage and non-volatile memory for long-term data retention. Additionally, or alternatively, the data storage 124 may include remote storage resources accessible to the device 102 via a network connection, such as cloud-based storage services or networked servers. In some examples, the output manager 122 and/or the data storage 124 may be integrated into or part of the housing 106 and/or the housing 108. In some other examples, the output manager 122 and/or the data storage 124 may be independent of the housing 106 and/or the housing 108.

The device 102 analyzes the sensor data 126 to dynamically determine a display to output visual content and to determine whether to output audio content. The device 102 can use the sensor data 126 to detect that a fold angle of the device satisfies a threshold value. If an ambient light of an environment of the device is less than a threshold value (e.g., low ambient light) and a user is within a threshold proximity, then the output manager 122 may display a mirrored version of visual content on the display 114 for reflection off of a darkened display 116. In some other examples, if an ambient light of an environment of the device is greater than a threshold value (e.g., high ambient light) and/or a user is outside of a threshold proximity (e.g., not within the threshold proximity), then the output manager 122 may display visual content at a display 116 and may darken the display 114 to reduce or avoid unintended reflection or glare caused by the display 114 at the display 116. The output manager 122 manages input received at the display 114 and/or at the display 116. If the mirrored version of the visual content is output at the display 114, and the device 102 receives input at the display 116, then the device 102 can map touch inputs on the display 116 to the mirrored version of the visual content at the display 114, providing for users to interact with the reflected content even when the display 116 appears dark.

The sensor data 126 includes the information collected by the sensors 110 and/or the sensors 112 at the device 102. This may include fold angle measurements from hall effect sensors or angle sensors in the hinge, ambient light levels from photodiodes or light-dependent resistors, user proximity data from capacitive sensors, and device orientation information from accelerometers and gyroscopes. For example, the sensor data 126 could indicate a 45 degree fold angle, low ambient light of 5 lux, and user presence within 30 cm of the device. The sensors may also detect when a photo sensor or proximity sensor is covered, which can be used as an additional trigger for activating the mirrored display mode, as this often indicates the user is holding the device in a specific way to view content discreetly.

The one or more threshold values 128 are defined values (e.g., predefined, configured by a user, configured by the device 102) used to trigger changes in device behavior based on sensor readings. Examples include, but are not limited to, a fold angle threshold range of 30 to 60 degrees for activating the output of the mirrored version of the visual content, an ambient light threshold of 10 lux below which the device 102 activates the output of the mirrored version of the visual content, and a user proximity threshold of 50 centimeters (cm) between the user and the housing 106 and/or the housing 108 below which the device 102 activates the output of the mirrored version of the visual content. If a fold angle, a proximity of the user, and the ambient light of an environment of the device 102 satisfy the threshold values 128, then the device 102 can automatically (e.g., without user input) activate the output of the mirrored version of the visual content, disable audio output, and enable a dark theme for further reduced light emission. Enabling the dark theme can include updating display settings to use darker colors, such as black or dark gray, for the background and lighter colors for text and other foreground elements. Additionally, or alternatively, enabling the dark theme can include reducing a brightness of the display 114 and/or the display 116. For example, when the device 102 activates the mirrored version of visual content on an upper display, the device 102 may concurrently apply a dark theme to the visual content, including inverting text colors, adjusting a color palette of images and icons to use darker shades, and reducing brightness of the upper display, dimming or darkening one or more user interface elements like borders, menu bars, or decorative graphics.

Output content 130 includes the visual content and audio content presented by the device 102. The visual content may include text messages, images, videos, or application interfaces displayed on either the display 114 and/or the display 116. If the device 102 outputs a mirrored version of the visual content at an upper display, then the visual content is reflected off of the lower display and appears in the correct orientation for a user perspective. Audio content can include, but is not limited to, alerts, message notifications, ringtones, or media playback through audio output components of the device 102 (e.g., one or more speakers), which may be silenced automatically if the criterion for outputting the mirrored version of the visual content is satisfied (e.g., the threshold values 128 are met).

By utilizing the sensors 110 and the sensors 112 across both the housing 106 and the housing 108, the device 102 can accurately detect a physical configuration and surrounding environment. The output manager 122 leverages the sensor data 126 to determine which display to output visual content, as well as whether to output audio content. Outputting a mirrored version of the visual content at an upper display for reflection off the lower display provides for improved power consumption at the device 102 and improved output quality of the visual content, while also reducing disturbance to others nearby. The device can map touch inputs from one display to mirrored content on the other display, which provides for the user to interact with the visual content at a display even when the display is not outputting the visual content.

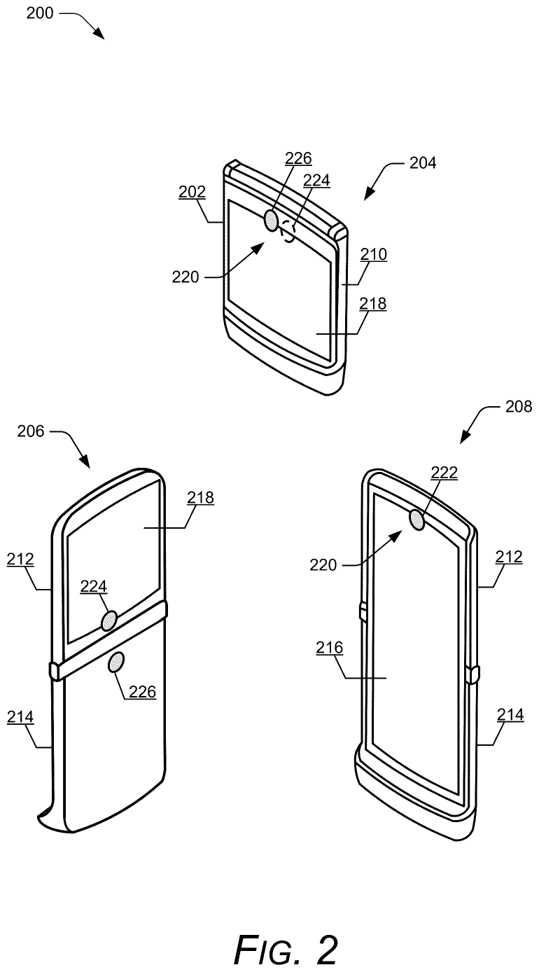

FIG. 2 illustrates an example 200 of a foldable mobile device 202 for visual content output management using sensor data in accordance with one or more implementations as described herein. The foldable mobile device 202 may be an example of the device 102 as described with reference to FIG. 1. Examples of a foldable mobile device or expandable mobile device may include any type of a wireless device, mobile device, mobile phone, flip phone, smartphone, client device, companion device, tablet, communication device, entertainment device, gaming device, media playback device, or any other type of computing, consumer, and/or electronic device. In the example 200, the foldable mobile device 202 is shown in a first view 204 in a folded form factor, and a back of the device is shown in a second view 206 in an opened form factor of the device. A front of the foldable mobile device 202 is also shown in a third view 208 in the opened form

### Factor of the Device.

In the example 200, the foldable mobile device 202 has a foldable housing 210, which is operational to fold the device from the opened form factor, as shown in the second view 206 and in the third view 208, to the folded form factor of the device, as shown in the first view 204. The foldable housing 210 of the foldable mobile device 202 includes a first half 212 of the foldable housing and a second half 214 of the foldable housing. Although housing components of the foldable housing 210 are indicated as the first half 212 and the second half 214 of the foldable housing, they may be greater than or less than half of the foldable housing that overlap to form a smaller device. Additionally, or alternatively, the first half 212 of the foldable housing 210 may also be referred to as the top half or the front half of the foldable mobile device 202, while the second half 214 of the foldable housing may also be referred to as the bottom half or back half of the device, given the perspectives shown in the second view 206 and the third view 208 of the foldable mobile device 202.

In some implementations, the foldable mobile device 202 may be a multi-screen device, having two or more display screens. In the example 200, the foldable mobile device 202 includes a relatively large primary display screen 216, and a relatively small secondary display screen 218. The primary display screen 216 may also be referred to as the inner or interior display screen (e.g., or is a two-part display screen), which is folded between the first half 212 and the second half 214 of the foldable housing 210 in the folded form factor of the foldable mobile device 202. The secondary display screen 218 may also be referred to as the outer or exterior display screen, which remains viewable in both the folded form factor of the foldable mobile device 202, as shown in the first view 204 of the device, and in the opened form factor of the foldable mobile device 202, as shown in the second view 206 of the device.

In the example 200, the primary display screen 216 is located on one side (e.g., the front side) of the foldable mobile device 202, as shown in the third view 208, and the secondary display screen 218 is located on the opposite side (e.g., the back side) of the foldable mobile device 202, as shown in the second view 206. The primary display screen 216 and the secondary display screen 218 on the opposite sides of the foldable mobile device 202 may be the same size, approximately the same size, or vary in different sizes. In the example 200, the secondary display screen 218 is smaller than the primary display screen 216 and may be used as a notification screen that displays any type of user interface or notifications associated with device applications on the foldable mobile device 202.

In some implementations, the foldable mobile device 202 in the example 200 includes a sensor system 220. The sensor system 220 may include, but is not limited to, a sensor 222, a sensor 224, and/or a sensor 226. The sensor 222, the sensor 224, and/or the sensor 226 may be sensors for detecting a proximity of a user to the foldable mobile device 202, sensors for detecting an ambient light of an environment of the foldable mobile device 202, and sensors for detecting a fold angle of the foldable mobile device 202 and may be positioned at different locations on the foldable mobile device 202. For example, the sensor 222 may be located near the edge of the primary display screen 216, the sensor 224 may be positioned on the back side of the second half 214, and the sensor 226 may be integrated into the secondary display screen 218. The foldable mobile device 202 may use sensor data from the sensor 222, the sensor 224, and the sensor 226 to determine whether to output visual content on the primary display screen 216, the secondary display screen 218, or both. For example, if the sensor data indicates that the fold angle is within a threshold range (e.g., the foldable mobile device 202 is partially open in a folded configuration), the user is within a threshold proximity to the foldable mobile device 202, and ambient light of an environment of the foldable mobile device 202 is below a threshold value, then the foldable mobile device 202 may output a mirrored version of visual content on an upper display screen while refraining from outputting visual content on the lower display screen. In some other examples, if the sensor data indicates that the user is outside the threshold proximity or that the ambient light exceeds the threshold value, then the foldable mobile device 202 may output visual content on the lower display screen while refraining from outputting visual content on the upper display screen. The dynamic selection of a display screen to output visual content using sensor data reduces excessive brightness, reduces disturbances to others nearby, and improves viewing experience in various lighting conditions.

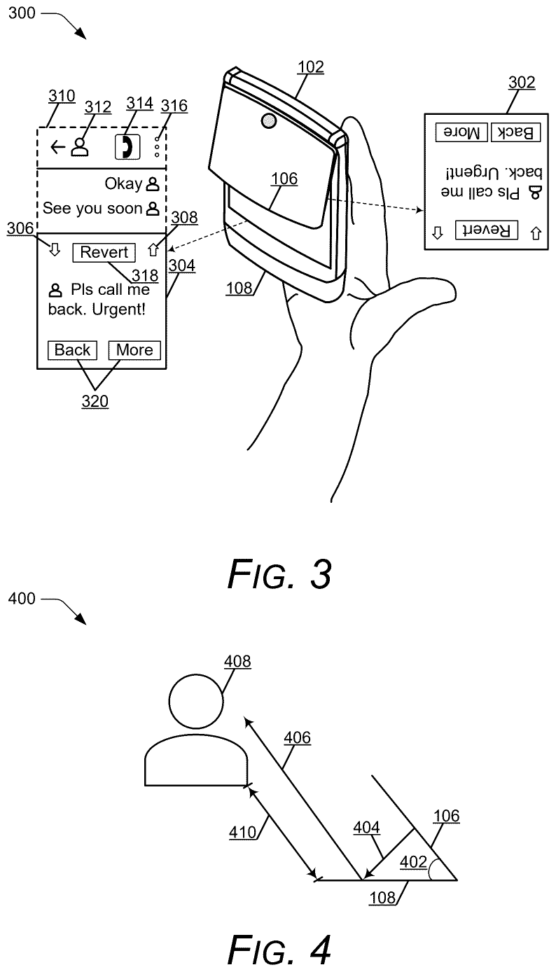

FIG. 3 illustrates an example environment 300 for visual content output management using sensor data in accordance with one or more implementations as described herein. The environment 300 may implement or be implemented by aspects of the example system 100 and the example 200. For example, the environment 300 includes a device 102, which may be an example of the device 102 and/or a foldable mobile device 202 as described with reference to FIGS. 1 and 2.

The environment 300 includes a device 102 with a housing 106 that is foldably coupled with a housing 108, as described with reference to FIG. 1. The device 102 displays a mirrored version of visual content 302 at a display of the housing 106, which appears as visual content 304 at a display of the housing 108. The visual content 304 can include a text value, such as “Pls call me back. Urgent!” and one or more interactive elements. The display of the housing 106 may be referred to as an upper display, while the display of the housing 108 may be referred to as a lower display. The device 102 uses sensor data from sensors at the housing 106 and/or at the housing 108 to determine which display to use for outputting the visual content 304. For example, if sensor data indicates that a fold angle between the housing 106 and the housing 108 is within a threshold range (e.g., between 30 and 60 degrees), ambient light is below a threshold value (e.g., less than 10 lux), and a user is within a threshold proximity (e.g., within 50 cm), then the device 102 may output the mirrored version of visual content 302 at the upper display, while refraining from outputting visual content at the lower display. Thus, a user can view reflected content on the darkened lower display without direct light emission from the lower display, reducing disturbance to others nearby. Additionally, or alternatively, if the threshold values are met (e.g., criterion or conditions for outputting the mirrored version of the visual content 302 are met), then the device 102 may refrain from outputting audio content and/or can activate a dark theme for further reduced light emission.

The visual content 304 includes a navigation control 306 and a navigation control 308 to enable user interaction with the visual content 304 reflected from the mirrored version of visual content 302. The navigation control 306 may provide for scrolling up through the visual content 304 (e.g., to view additional visual content 310), while the navigation control 308 enables scrolling down through the visual content 304. The additional visual content 310 can include additional text values (e.g., “Okay,” and “See you soon”) in a messaging history. If a user interacts with the navigation control 306 and the navigation control 308 on the lower display (e.g., at the housing 108), then the device 102 maps the touch inputs to corresponding locations at the upper display (e.g., at the housing 106) where the mirrored version of visual content 302 is output or displayed. Displaying a mirrored version of visual content 302 enhances data security for the information displayed, as a user can view the information without the information being displayed to others in the area due to the angle of the displays.

To facilitate the mapping of input received at the lower display to the mirrored version of visual content 302 at the upper display, the device 102 may use the detected fold angle to calculate a transformation between touch coordinates on the lower display and corresponding positions on the upper display. For example, if a user taps a location (x₁, y₁) on the lower display to select additional visual content 310, then the device 102 can apply a formula, such as (x₂, y₂)=(width−x₁, height−y₁), to determine the corresponding location on the upper display, adjusting for the current fold angle. Mapping the input between displays provides for users to interact with the reflected content as if they were directly touching the upper display. The content displayed on the upper display is flipped or mirrored so that when reflected onto the lower display, the visual content 304 appears in the correct orientation from a perspective of the user (e.g., text messages and other content is readable).

The additional visual content 310 can include a user account icon 312 that provides for a user to identify the user account and to view settings related to the user account (e.g., if input is received at the user account icon 312). The additional visual content 310 may also include one or more interactive controls, such as an interactive control 314, an interactive control 316, an interactive control 318, and one or more interactive controls 320. The device can map input received at the interactive controls at a lower display to an upper display, providing for users to access different functions or navigate through the visual content 304 and additional visual content 310 (e.g., even if the visual content 304 and additional visual content 310 is mirrored from the upper display to the lower display). For example, the interactive control 314 may open a call history or a keypad for initiating a call. The interactive control 316 can display additional functions or options supported by the device 102. The interactive control 318, which is labeled “Revert,” provides for the user to switch between outputting the mirrored version of the visual content 302 and outputting the visual content 304 at one or both of the upper display or the lower display without mirroring the visual content 304. For example, the interactive control 318 provides for the device 102 to dynamically switch between outputting the mirrored version of visual content 302 and outputting the visual content 304 without mirroring the visual content 304 based on an environment and user preferences, among other factors. The interactive controls 320 can provide for a device 102 to view different visual content (e.g., previous visual content if the interactive control 320 labeled “Back” is selected or an extension of the visual content 304 if the interactive control 320 labeled “More” is selected).

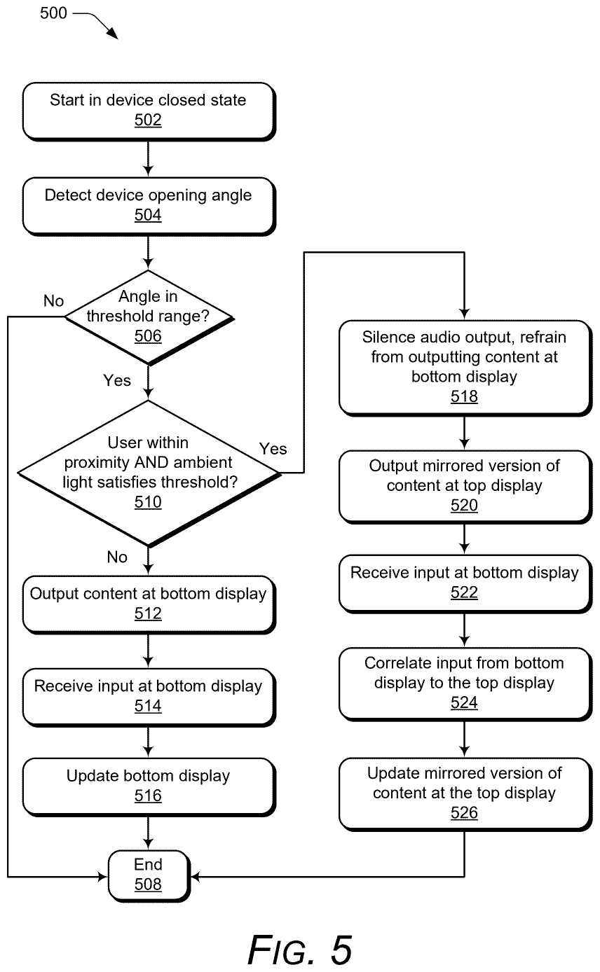

FIG. 4 illustrates an example display diagram 400 for visual content output management using sensor data in accordance with one or more implementations as described herein. The display diagram 400 may implement or be implemented by aspects of the example system 100, the example 200, and the example environment 300. For example, the display diagram 400 depicts a fold angle 402 of a housing 106 relative to a housing 108 of a device, which may be an example of the device 102, the housing 106, and the housing 108, as described with reference to FIG. 1. Although the device is illustrated as including two housings (e.g., the housing 106 and the housing 108), the device can include any numerical quantity of housings.

In some examples, if the fold angle 402 is within a threshold range (e.g., between 30 and 60 degrees), then the device can output a mirrored version of visual content in the output direction 404 from a display at the housing 106. The mirrored version of the visual content is then reflected towards the user 408 in the view direction 406, providing for the user 408 to view the visual content on the darkened surface of a display at the housing 108. The user 408 is positioned at a distance 410 from the device (e.g., the housing 108 and/or the housing 106). The device can use sensors at the housing 106 and/or the housing 108 to detect if this distance 410 is within a threshold proximity to the device (e.g., within 50 cm). If the fold angle 402 is within the threshold range, the user 408 is within the threshold proximity, and ambient light conditions are below a threshold value, then the device outputs the mirrored version of the visual content at a display of the housing 106 for reflection from the display at the housing 108. In some examples, the threshold range may be defined such that the visual content is visible to the user 408, improving data security and reducing light emission towards others in the surrounding environment. The user 408 can interact with the reflected visual content at the housing 108 to by providing input, and the device can map the input to corresponding locations on the mirrored content displayed at the housing 106.

If the fold angle 402 exceeds the threshold range, then the device can activate output of visual content at both displays of the device. If the fold angle 402 is less than the threshold range, then the device can deactivate (e.g., turn off, cancel output, refrain from outputting) the visual content at both displays of the device. If the distance 410 exceeds the threshold proximity and/or if the ambient light exceeds a threshold value, then the device may revert to displaying visual content directly at a display of the housing 108 (e.g., rather than using the mirrored reflection method).

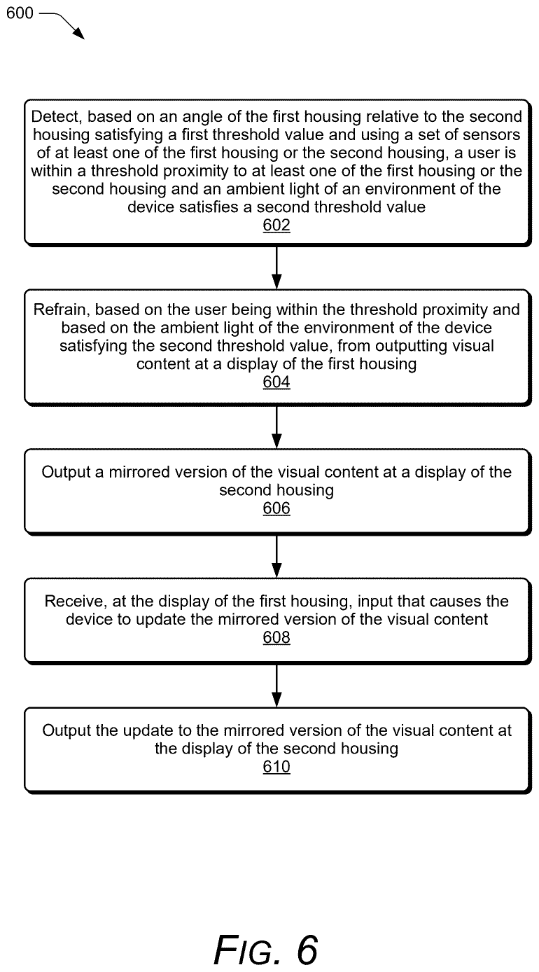

FIG. 5 illustrates an example flowchart 500 for visual content output management using sensor data in accordance with one or more implementations as described herein. The example flowchart 500 may implement aspects of the example system 100, the example 200, the example environment 300, and the example display diagram 400. For example, the example flowchart 500 can be implemented by a device, which may be an example of the device 102 and/or a foldable mobile device 202 as described with reference to FIG. 1 and FIG. 2. Alternative examples of the following may be implemented, where some processes are performed in a different order than described or are not performed. In some cases, processes may include additional features not mentioned below, or further processes may be added.

At 502, the device starts in a closed state. In some cases, the closed state may be defined as a configuration in which the fold angle between a first housing and a second housing of the device is less than a threshold value, such as 10 degrees or less. Additionally, or alternatively, the closed state may be defined as a configuration in which multiple surfaces or edges of the device housings are in contact (e.g., touching).

At 504, the device detects a device opening angle. For example, sensors in the hinge or housings of the device may measure the angle between the first housing and the second housing as the device is unfolded. The angle detection may be performed using various sensor types, including but not limited to potentiometers integrated into the hinge mechanism, hall effect sensors that measure magnetic field strength as the distance between housings changes, accelerometers that detect the relative orientation of each housing, or optical sensors that measure the gap between housings. The device may continuously and/or periodically monitor for changes (e.g., updates) in the fold angle in real-time.

At 506, a determination is made as to whether the angle is within a threshold range (e.g., satisfies at least one threshold). For example, the device may check if the detected angle is between 30 and 60 degrees. If the angle is not within the threshold range (e.g., “No”), then the device may end the process at 508. The threshold range may be user-configurable through device settings. For example, users who frequently use the device in bed may prefer a narrower range of 35 to 45 degrees, while users who place the device on a desk may prefer a wider range of 25 to 70 degrees. If the angle is in the threshold range (e.g., “Yes”), then at 510, a determination is made as to whether a user is within a proximity of the device and an ambient light of an environment of the device satisfies a threshold (e.g., is less than a threshold value). For example, proximity sensors may detect if a user is within 50 cm of the device, and light sensors may check if ambient light is below 10 lux.

If the conditions at 510 are not met (e.g., “No”), then at 512, the device outputs visual content at a bottom display of a housing. At 514, the device receives an input at the bottom display. At 516, the device updates the bottom display based on the received input. At 508, the device may end the process. When outputting content at the bottom display, the device may automatically adjust brightness levels based on the detected ambient light conditions. For example, in bright outdoor environments (e.g., greater than 1000 lux), the device may increase display brightness to 80 to 100% of maximum capacity to maintain visibility. In moderately lit indoor environments (e.g., 100 to 1000 lux), the device may set brightness to 40 to 60% of maximum capacity. The device may also apply content-aware brightness adjustments, where predominantly dark content (e.g., a night mode interface) receives lower brightness settings than predominantly bright content (e.g., a document with a white background).

If the conditions at 510 are met (e.g., “Yes”), then at 518, the device silences audio output and refrains from outputting visual content at the bottom display. At 520, the device outputs a mirrored version of the visual content at the top display. The mirrored version of the visual content may include updates to the visual content to enhance reflectivity and readability when viewed as a reflection. For example, the device may increase contrast ratios and/or adjust color temperature toward cooler tones, which may reflect more effectively than warmer tones.

At 522, the device receives input at the bottom display. At 524, the device correlates input from the bottom display to the top display. For example, the device can map touch coordinates at the bottom display to corresponding positions on the mirrored content at the top display. At 526, the device updates the mirrored version of content at the top display based on the correlated input. At 508, the device may end the process. The mapping between displays may account for the fold angle and potential parallax effects based on user viewing position. Parallax effects include an apparent displacement or difference in a perceived position of an object when viewed from different angles or positions, which can impact how touch inputs on one display are mapped to corresponding locations on another display of a device. For example, if the user is viewing from a slight side angle rather than directly in front of the device, the mapping algorithm may apply a perspective correction factor to the mapping.

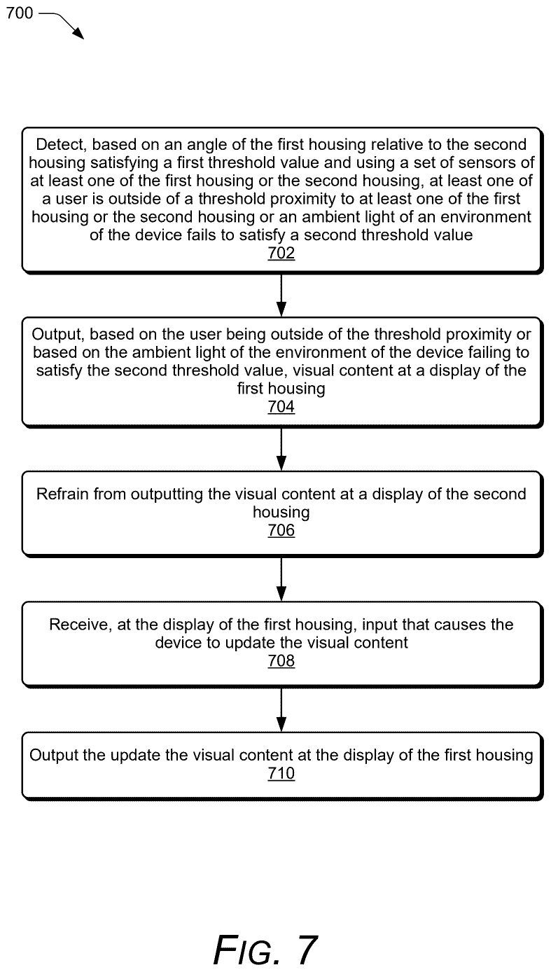

FIG. 6 illustrates an example method 600 for visual content output management using sensor data. The order in which the method is described is not intended to be construed as a limitation, and any number or combination of the described method operations can be performed in any order to perform a method, or an alternate method. The method 600 may be performed by a device, which may be an example of the device 102 as described with reference to FIG. 1. For example, the device includes a first housing and a second housing that are foldably coupled as part of a device housing.

At 602, a device detects that a user is within a threshold proximity to at least one of the first housing or the second housing and an ambient light of an environment of the device satisfies a second threshold value (e.g., is less than the second threshold value) using a set of sensors of at least one of the first housing or the second housing. The device can use a sensor of at least one of the first housing or the second housing to detect an angle of the first housing relative to the second housing. The device can detect that the user is within the threshold proximity to the housings and the ambient light satisfies the second threshold based on an angle of a first housing relative to a second housing satisfying a first threshold value (e.g., being within a range).

At 604, the device refrains from outputting visual content at a display of the first housing based on the user being within the threshold proximity and based on the ambient light of the environment of the device satisfying the second threshold value. Refraining from outputting the visual content can include canceling, not displaying, or turning off the visual content, while maintaining input functionality at the display.

At 606, the device outputs a mirrored version of the visual content at a display of the second housing. In some cases, to output the mirrored version of the visual content at the display of the second housing, the device sets a brightness level of the display of the second housing to satisfy a third threshold value (e.g., less than the third threshold value).

At 608, the device receives, at the display of the first housing, input that causes the device to update the mirrored version of the visual content. At 610, the device outputs the update to the mirrored version of the visual content at the display of the second housing. Additionally, or alternatively, the device may refrain from outputting audio content at the device based on the user being within the threshold proximity and based on the ambient light of the environment of the device satisfying the second threshold value.

In some cases, the device may receive additional input at a selectable control output at the display of the second housing. The device can cancel outputting of the mirrored version of the visual content at the display of the second housing responsive to the additional input. The device can output the visual content at the display of the first housing. The device may generate an update to the mirrored version of the visual content based on a mapping between first coordinates of the input at the display of the first housing and second coordinates corresponding to the display of the second housing. The second coordinates corresponding to the display of the second housing are based on the first coordinates and the angle of the first housing relative to the second housing. In some cases, the display of the second housing is located above the display of the first housing to cause the mirrored version of the visual content to be reflected from the display of the second housing to the display of the first housing.

FIG. 7 illustrates an example method 700 for visual content output management using sensor data in accordance with one or more cases. The order in which the method is described is not intended to be construed as a limitation, and any number or combination of the described method operations can be performed in any order to perform a method, or an alternate method. The method 700 may be performed by a device, which may be an example of the device 102 as described with reference to FIG. 1. For example, the device includes a first housing and a second housing that are foldably coupled as part of a device housing.

At 702, a device detects, based on an angle of a first housing relative to a second housing satisfying a first threshold value and using a set of sensors of at least one of the first housing or the second housing, at least one of a user is outside of a threshold proximity to at least one of the first housing or the second housing or an ambient light of an environment of the device fails to satisfy a second threshold value. The device includes at least one memory and at least one processor coupled with the at least one memory. The first housing and second housing are foldably coupled as part of a device housing.

At 702, a device detects at least one of a user is outside of a threshold proximity to at least one of the first housing or the second housing or an ambient light of an environment of the device fails to satisfy a second threshold value (e.g., is greater than the second threshold value) using a set of sensors of at least one of the first housing or the second housing. The device can use a sensor of at least one of the first housing or the second housing to detect an angle of the first housing relative to the second housing. The device can detect that the user is outside of the threshold proximity to the housings and the ambient light fails to satisfy the second threshold based on an angle of a first housing relative to a second housing satisfying a first threshold value (e.g., being within a range).

At 704, the device outputs visual content at a display of the first housing based on the user being outside of the threshold proximity or based on the ambient light of the environment of the device failing to satisfy the second threshold value. At 706, the device refrains from outputting the visual content at a display of the second housing.

At 708, the device receives input at the display of the first housing that causes the device to update the visual content. At 710, the device outputs the update to the visual content at the display of the first housing.

The device may output audio content at the device based on the user being outside of the threshold proximity or based on the ambient light of the environment of the device failing to satisfy the second threshold value. In some cases, the device may receive additional input at a selectable control output at the display of the second housing. The device may cancel outputting the visual content at the display of the first housing responsive to the additional input. The device may output a mirrored version of the visual content at the display of the second housing. To output the mirrored version of the visual content at the display of the second housing, the device may set a brightness level of the display of the second housing to satisfy a third threshold value (e.g., less than the third threshold value). The device may generate the update to the mirrored version of the visual content based on a mapping between first coordinates of the input at the display of the first housing and second coordinates corresponding to the display of the second housing. The second coordinates corresponding to the display of the second housing are based on the first coordinates and the angle of the first housing relative to the second housing. In some cases, the display of the second housing is located above the display of the first housing to cause the mirrored version of the visual content to be reflected from the display of the second housing to the display of the first housing.

The example flowchart 500, the example method 600, and the example method 700, are described with reference to respective FIGS. 5, 6, and 7 in accordance with one or more implementations of visual content output management using sensor data, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 8 illustrates various components of an example device 800, which can implement aspects of the techniques and features for visual content output management using sensor data, as described herein. The example device 800 can be implemented as any of the devices described with reference to the previous FIGS. 1 through 7, such as any type of a wireless device, mobile device, mobile phone, flip phone, client device, companion device, paired device, display device, tablet, wearable device, computing, communication, entertainment, gaming, media playback, and/or any other type of computing, consumer, and/or electronic device. For example, the device 102, as described with reference to FIGS. 1 through 7, may be implemented as the example device 800.

The example device 800 can include various, different communication devices 802 that enable wired and/or wireless communication of device data 804 with other devices. The device data 804 can include any of the various device's data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The I/O interfaces 806 can be used to couple the device to any type of components, peripherals, and/or accessory devices, such as a computer input device that may be integrated with the example device 800. The I/O interfaces 806 may also include data input ports via which any type of data, information, media content, communications, messages, and/or inputs can be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a SoC that processes computer-executable instructions. The processor system 808 may be implemented at least partially in computer hardware, which can include components of an integrated circuit or on-chip system, an ASIC, a FPGA, a CPLD, and other implementations in silicon and/or other hardware. Alternatively, or in addition, the device can be implemented with any one or combination of software, hardware, firmware, or fixed logic circuitry that may be implemented in connection with processing and control circuits, which are generally identified as processing and control 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 can be maintained as software instructions with a memory device 812 and executed by the processor system 808 as a software application. The device applications 814 may also include a device manager, such as any form of a control application, software application, signal-processing and control module, code that is specific to a particular device, a hardware abstraction layer for a particular device, and so on.

In this example, the device 800 includes an output manager 818 that implements various aspects of the described features and techniques described herein. The output manager 818 can be implemented with hardware components and/or in software as one of the device applications 814, such as when the example device 800 is implemented as the device 102 described with reference to FIGS. 1 through 7. An example of the output manager 818 is the output manager 122 implemented in the device 102, such as a software application and/or as hardware components in the wireless device. In one or more implementations, the output manager 818 may include independent processing, memory, and logic components as a computing and/or electronic device integrated with the example device 800.

The example device 800 can also include a microphone 820 and/or camera devices 822, as well as proximity and/or motion sensors 824, such as may be implemented as components of an inertial measurement unit (IMU), and geographical location information sensors (e.g., GPS to obtain a current geographic location of the client device or a user of the client device). The proximity and/or motion sensors 824 can be implemented with various sensors 826, such as a gyroscope, an accelerometer, and/or other types of motion sensors to sense motion of the device. The motion sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources, such as when the device is implemented as a wireless device and/or a device 102. The power sources may include a charging and/or power system, and can be implemented as a flexible strip battery, a rechargeable battery, a charged super-capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In one or more implementations, the audio system and/or the display system are integrated components of the example device 800. Alternatively, the audio system and/or the display system are external, peripheral components to the example device.

Although implementations of visual content output management using sensor data have been described in language specific to features and/or methods, the appended claims are not necessarily limited to the specific features or methods described. Rather, the specific features and methods are disclosed as example implementations for visual content output management using sensor data, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a device for wireless communications, the device including at least one memory, a device housing including a first housing and a second housing foldably coupled with the first housing, and at least one processor coupled with the at least one memory and operable to cause the device to detect, based on an angle of the first housing relative to the second housing satisfying a first threshold value and using a set of sensors of at least one of the first housing or the second housing, a user is within a threshold proximity to at least one of the first housing or the second housing and an ambient light of an environment of the device satisfies a second threshold value, refrain, based on the user being within the threshold proximity and based on the ambient light of the environment of the device satisfying the second threshold value, from outputting visual content at a display of the first housing, output a mirrored version of the visual content at a display of the second housing, receive, at the display of the first housing, input that causes the device to update the mirrored version of the visual content, and output the update to the mirrored version of the visual content at the display of the second housing.

In some aspects, the techniques described herein relate to a device, where the at least one processor is further operable to cause the device to detect, using a sensor of at least one of the first housing or the second housing, the angle of the first housing relative to the second housing satisfies the first threshold value.

In some aspects, the techniques described herein relate to a device, where to output the mirrored version of the visual content at the display of the second housing, the at least one processor is further operable to cause the device to set a brightness level of the display of the second housing to satisfy a third threshold value.

In some aspects, the techniques described herein relate to a device, where the at least one processor is further operable to cause the device to refrain, based on the user being within the threshold proximity and based on the ambient light of the environment of the device satisfying the second threshold value, from outputting audio content at the device.

In some aspects, the techniques described herein relate to a device, where the at least one processor is further operable to cause the device to receive, at a selectable control output at the display of the second housing, additional input, cancel, responsive to the additional input, outputting of the mirrored version of the visual content at the display of the second housing, and output the visual content at the display of the first housing.

In some aspects, the techniques described herein relate to a device, where the at least one processor is further operable to cause the device to generate the update to the mirrored version of the visual content based on a mapping between first coordinates of the input at the display of the first housing and second coordinates corresponding to the display of the second housing, where the second coordinates corresponding to the display of the second housing are based on the first coordinates and the angle of the first housing relative to the second housing.

In some aspects, the techniques described herein relate to a device, where the display of the second housing is located above the display of the first housing to cause the mirrored version of the visual content to be reflected from the display of the second housing to the display of the first housing.

In some aspects, the techniques described herein relate to a device for wireless communications, the device including at least one memory, a device housing including a first housing and a second housing foldably coupled with the first housing, and at least one processor coupled with the at least one memory and operable to cause the device to detect, based on an angle of the first housing relative to the second housing satisfying a first threshold value and using a set of sensors of at least one of the first housing or the second housing, at least one of a user is outside of a threshold proximity to at least one of the first housing or the second housing or an ambient light of an environment of the device fails to satisfy a second threshold value, output, based on the user being outside of the threshold proximity or based on the ambient light of the environment of the device failing to satisfy the second threshold value, visual content at a display of the first housing, refrain from outputting the visual content at a display of the second housing, receive, at the display of the first housing, input that causes the device to update the visual content, and output the update the visual content at the display of the first housing.

In some aspects, the techniques described herein relate to a device, where the at least one processor is further operable to cause the device to detect, using a sensor of at least one of the first housing or the second housing, the angle of the first housing relative to the second housing satisfies the first threshold value.

In some aspects, the techniques described herein relate to a device, where the at least one processor is further operable to cause the device to output, based on the user being outside of the threshold proximity or based on the ambient light of the environment of the device failing to satisfy the second threshold value, audio content at the device.

In some aspects, the techniques described herein relate to a device, where the at least one processor is further operable to cause the device to receive, at a selectable control output at the display of the second housing, additional input, cancel, responsive to the additional input, outputting the visual content at the display of the first housing, and output a mirrored version of the visual content at the display of the second housing.

In some aspects, the techniques described herein relate to a device, where to output the mirrored version of the visual content at the display of the second housing, the at least one processor is further operable to cause the device to set a brightness level of the display of the second housing to satisfy a third threshold value.

In some aspects, the techniques described herein relate to a device, where the at least one processor is further operable to cause the device to generate the update to the mirrored version of the visual content based on a mapping between first coordinates of the input at the display of the first housing and second coordinates corresponding to the display of the second housing, where the second coordinates corresponding to the display of the second housing are based on the first coordinates and the angle of the first housing relative to the second housing.

In some aspects, the techniques described herein relate to a device, where the display of the second housing is located above the display of the first housing to cause the mirrored version of the visual content to be reflected from the display of the second housing to the display of the first housing.

In some aspects, the techniques described herein relate to a system, including a first housing integrated with a first display, a second housing integrated with a second display, where the second housing is foldably coupled with the first housing, and an output manager to detect, based on an angle of the first housing relative to the second housing satisfying a first threshold value and using a set of sensors of at least one of the first housing or the second housing, a user is within a threshold proximity to at least one of the first housing or the second housing and an ambient light of an environment associated with the first housing and the second housing satisfies a second threshold value, refrain, based on the user being within the threshold proximity and based on the ambient light of the environment associated with the first housing and the second housing satisfying the second threshold value, from outputting visual content at the first display, output a mirrored version of the visual content at the second display, receive, at the first display, input that causes the second display to update the mirrored version of the visual content, and output the update to the mirrored version of the visual content at the second display.

In some aspects, the techniques described herein relate to a system, where the output manager is further configured to detect, using a sensor of at least one of the first housing or the second housing, the angle of the first housing relative to the second housing satisfies the first threshold value.

In some aspects, the techniques described herein relate to a system, where to output the mirrored version of the visual content at the second display, the output manager is configured to set a brightness level of the second display to satisfy a third threshold value.

In some aspects, the techniques described herein relate to a system, where the output manager is further configured to refrain, based on the user being within the threshold proximity and based on the ambient light of the environment associated with the first housing and the second housing satisfying the second threshold value, from outputting audio content.

In some aspects, the techniques described herein relate to a system, where the output manager is further configured to receive, at a selectable control output at the second display, additional input, cancel, responsive to the additional input, outputting of the mirrored version of the visual content at the second display, and output the visual content at the first display.

In some aspects, the techniques described herein relate to a system, where the output manager is further configured to generate the update to the mirrored version of the visual content based on a mapping between first coordinates of the input at the first display and second coordinates corresponding to the second display, where the second coordinates are based on the first coordinates and the angle of the first housing relative to the second housing, and where the second display is located above the first display to cause the mirrored version of the visual content to be reflected from the second display to the first display.

1. A device for wireless communications, the device comprising:
at least one memory;
a device housing comprising a first housing and a second housing foldably coupled with the first housing; and
at least one processor coupled with the at least one memory and operable to cause the device to:
detect, based at least in part on an angle of the first housing relative to the second housing satisfying a first threshold value and using a plurality of sensors of at least one of the first housing or the second housing, a user is within a threshold proximity to at least one of the first housing or the second housing and an ambient light of an environment of the device satisfies a second threshold value;
refrain, based at least in part on the user being within the threshold proximity and based at least in part on the ambient light of the environment of the device satisfying the second threshold value, from outputting visual content at a display of the first housing;
output a mirrored version of the visual content at a display of the second housing;
receive, at the display of the first housing, input that causes the device to update the mirrored version of the visual content; and
output the update to the mirrored version of the visual content at the display of the second housing.

2. The device of claim 1, wherein the at least one processor is further operable to cause the device to detect, using a sensor of at least one of the first housing or the second housing, the angle of the first housing relative to the second housing satisfies the first threshold value.

3. The device of claim 1, wherein to output the mirrored version of the visual content at the display of the second housing, the at least one processor is further operable to cause the device to set a brightness level of the display of the second housing to satisfy a third threshold value.

4. The device of claim 1, wherein the at least one processor is further operable to cause the device to refrain, based at least in part on the user being within the threshold proximity and based at least in part on the ambient light of the environment of the device satisfying the second threshold value, from outputting audio content at the device.

5. The device of claim 1, wherein the at least one processor is further operable to cause the device to:
receive, at a selectable control output at the display of the second housing, additional input;
cancel, responsive to the additional input, outputting of the mirrored version of the visual content at the display of the second housing; and
output the visual content at the display of the first housing.

6. The device of claim 1, wherein the at least one processor is further operable to cause the device to generate the update to the mirrored version of the visual content based at least in part on a mapping between first coordinates of the input at the display of the first housing and second coordinates corresponding to the display of the second housing, wherein the second coordinates corresponding to the display of the second housing are based at least in part on the first coordinates and the angle of the first housing relative to the second housing.

7. The device of claim 1, wherein the display of the second housing is located above the display of the first housing to cause the mirrored version of the visual content to be reflected from the display of the second housing to the display of the first housing.

8. A device for wireless communications, the device comprising:
at least one memory;
a device housing comprising a first housing and a second housing foldably coupled with the first housing; and
at least one processor coupled with the at least one memory and operable to cause the device to:
detect, based at least in part on an angle of the first housing relative to the second housing satisfying a first threshold value and using a plurality of sensors of at least one of the first housing or the second housing, at least one of a user is outside of a threshold proximity to at least one of the first housing or the second housing or an ambient light of an environment of the device fails to satisfy a second threshold value;
output, based at least in part on the user being outside of the threshold proximity or based at least in part on the ambient light of the environment of the device failing to satisfy the second threshold value, visual content at a display of the first housing;
refrain from outputting the visual content at a display of the second housing;
receive, at the display of the first housing, input that causes the device to update the visual content; and
output the update the visual content at the display of the first housing.

9. The device of claim 8, wherein the at least one processor is further operable to cause the device to detect, using a sensor of at least one of the first housing or the second housing, the angle of the first housing relative to the second housing satisfies the first threshold value.

10. The device of claim 8, wherein the at least one processor is further operable to cause the device to output, based at least in part on the user being outside of the threshold proximity or based at least in part on the ambient light of the environment of the device failing to satisfy the second threshold value, audio content at the device.

11. The device of claim 8, wherein the at least one processor is further operable to cause the device to:
receive, at a selectable control output at the display of the second housing, additional input;
cancel, responsive to the additional input, outputting the visual content at the display of the first housing; and
output a mirrored version of the visual content at the display of the second housing.

12. The device of claim 11, wherein to output the mirrored version of the visual content at the display of the second housing, the at least one processor is further operable to cause the device to set a brightness level of the display of the second housing to satisfy a third threshold value.

13. The device of claim 11, wherein the at least one processor is further operable to cause the device to generate the update to the mirrored version of the visual content based at least in part on a mapping between first coordinates of the input at the display of the first housing and second coordinates corresponding to the display of the second housing, wherein the second coordinates corresponding to the display of the second housing are based at least in part on the first coordinates and the angle of the first housing relative to the second housing.

14. The device of claim 11, wherein the display of the second housing is located above the display of the first housing to cause the mirrored version of the visual content to be reflected from the display of the second housing to the display of the first housing.

15. A system, comprising:
a first housing integrated with a first display;
a second housing integrated with a second display, wherein the second housing is foldably coupled with the first housing; and
an output manager to:
detect, based at least in part on an angle of the first housing relative to the second housing satisfying a first threshold value and using a plurality of sensors of at least one of the first housing or the second housing, a user is within a threshold proximity to at least one of the first housing or the second housing and an ambient light of an environment associated with the first housing and the second housing satisfies a second threshold value;
refrain, based at least in part on the user being within the threshold proximity and based at least in part on the ambient light of the environment associated with the first housing and the second housing satisfying the second threshold value, from outputting visual content at the first display;
output a mirrored version of the visual content at the second display;
receive, at the first display, input that causes the second display to update the mirrored version of the visual content; and
output the update to the mirrored version of the visual content at the second display.

16. The system of claim 15, wherein the output manager is further configured to detect, using a sensor of at least one of the first housing or the second housing, the angle of the first housing relative to the second housing satisfies the first threshold value.

17. The system of claim 15, wherein to output the mirrored version of the visual content at the second display, the output manager is configured to set a brightness level of the second display to satisfy a third threshold value.

18. The system of claim 15, wherein the output manager is further configured to refrain, based at least in part on the user being within the threshold proximity and based at least in part on the ambient light of the environment associated with the first housing and the second housing satisfying the second threshold value, from outputting audio content.

19. The system of claim 15, wherein the output manager is further configured to:
receive, at a selectable control output at the second display, additional input;
cancel, responsive to the additional input, outputting of the mirrored version of the visual content at the second display; and
output the visual content at the first display.

20. The system of claim 15, wherein the output manager is further configured to generate the update to the mirrored version of the visual content based at least in part on a mapping between first coordinates of the input at the first display and second coordinates corresponding to the second display, wherein the second coordinates are based at least in part on the first coordinates and the angle of the first housing relative to the second housing, and wherein the second display is located above the first display to cause the mirrored version of the visual content to be reflected from the second display to the first display.
